(19) United States
(12) Patent Application Publication
(10) Pub. No.: US 2015/0019040 A1
(43) Pub. Date: Jan. 15, 2015

(54) CONTROLLING SYSTEM AND DATA COLLECTING/DISPLAYING METHOD

(71) Applicant: Azbil Corporation, Tokyo (JP)

(72) Inventors: Masato TANAKA, Tokyo (JP); Eisuke TOYODA, Tokyo (JP); Tomoyasu MAEDA, Tokyo (JP); Fumihiro SUGAWARA, Tokyo (JP)

(73) Assignee: AZBIL CORPORATION, Tokyo (JP)

(21) Appl. No.: 14/329,479

(22) Filed: Jul. 11, 2014

(30) Foreign Application Priority Data
Jul. 12, 2013 (JP) 2013-146232

(51) Int. Cl. G05D 23/19

(52) U.S. Cl. CPC G05D 23/1917
USPC 700/299

(57) ABSTRACT

A regulator has: a data recording portion recording a setting value; an elapsed time measuring portion measuring elapsed time after commencement of data collection; a data collection initiating portion initiating the data collection if a direction of change of the setting value is a direction of change of the setting value that is a trigger for starting the data collection, when the data collection is stopped; a data collection terminating portion terminating the data collection when time elapsed after the commencement of the data collection has arrived at a data collection termination time limit, when the data collection is being performed; and a data displaying portion switching a display of a graph display of most recent time-series data, from the commencement of most recent data collection until termination of the most recent data collection, recorded by the data recording portion, when the data collection has been completed.

### CROSS REFERENCE TO RELATED APPLICATION

This application claims priority under 35 U.S.C. §119 to Japanese Patent Application No. 2013-146232, filed on Jul. 12, 2013, the entire content of which being hereby incorporated herein by reference.

### FIELD OF TECHNOLOGY

The present invention relates to a controlling system that includes a controller, such as a temperature controller, and, in particular, relates to a controller that is provided with a data collecting function.

### BACKGROUND

Temperature controllers that are equipped with PID controlling functions are used in order to control temperatures in heat treatment furnaces, and the like. In a temperature regulator, it is necessary to set a large number of parameters, such as PID parameters. The temperature regulator performs PID calculations using the PID parameters, to output a manipulated variable MV that will cause the measured temperature PV to go to the setting value SP that is set to the target temperature. This makes it possible to cause the measured temperature PV (the manipulated variable PV) to approach the target temperature (the setting value SP). Consequently, setting of the PID parameters, and the like, is necessary and important.

The control result information (data for characteristic values in control response, such as the time to arrival at the setting value, the amount of overshoot, and so forth) is useful information, as the result of control for the actual control target, when ascertaining states wherein there are problems in control, and when adjusting the PID parameters. Because of this, a function is executed wherein characteristic values for the control response within the temperature controller are calculated, and are stored within the temperature controller, as the series of control operations, such as heating and cooling, are performed. See, for example, Japanese Unexamined Patent Application Publication 2009-217439 (the “JP '439”). On the other hand, there are also devices, such as data loggers, that collect and record all measured data. See, for example, Japanese Unexamined Patent Application Publication 2008-286603 (the “JP '603”). The data collecting functions disclosed in these JP '439 and JP '603 enable the characteristic values for the control response in PID control, or all time series data, to be collected, to be subject to monitoring, and to be processed as subject to analysis.

However, in temperature control there are heaters, such as halogen lamps, able to increase temperatures rapidly, at more than 100° C. per second. These halogen lamps are used as rapid-heating heaters in, for example, single-wafer annealing furnaces for the front-end processes in semiconductor manufacturing processing, for example. See, for example, Japanese Unexamined Patent Application Publication 2005-260262 (the “JP '262”).

This type of rapid-heating heater is used in a manufacturing process wherein rapid heating and cooling is performed repetitively. In this manufacturing process, products that are the target of processing are substituted in short time intervals with each individual heating/cooling cycle, and thus it is necessary to check this critical heating/cooling status during each individual short time interval. That is, some method is necessary that enables the operator to check the heating/cooling status intuitively. In such a case, preferably checks are performed that include time synchronization of the respective changes in the manipulated variable MV, the measured temperature PV, the electric current in the heater, and the like, with checks that include how each has shifted temporally.

In measurement data collection using a data logger, as disclosed in Patent Citation 2, collective data continuously, with a repetition of the heating/cooling operations as a single set of time-series data, enables continuous data collection wherein shifts in the data with uniform regularity can be seen. However, checks of the division, into individual data sets, of the data in single heating/cooling operations, are difficult to achieve due to the difficulty in time synchronization.

Moreover, in the technology disclosed in Patent Citation 1, the information that can be stored is limited, which is inadequate as a data collecting/displaying function, and the information is inadequate for the operator to confirm the state of rising/falling movement of the process (the state of heating/cooling).

The present invention was created to solve the problems described above, and the object thereof is to provide a controlling system and a data collecting/displaying method wherein it is possible for an operator to confirm quickly the state of rising and falling movement (the state of heating and cooling) with each rising/falling operation (for example, with each heating/cooling operation), when a process variable repeatedly rises and falls.

### SUMMARY

A controlling system according to the present disclosure includes: a manipulated variable calculating portion that calculates and outputs, with each operating period, a manipulated variable MV based on a setting value SP and a process variable PV; an elapsed time measuring portion that measures elapsed time after commencement of data collection; a data recording portion that records, with each operating period, the setting value SP, the process variable PV, and/or the manipulated variable MV, as data to be collected; a data collection initiating portion that activates the data recording portion, to start data collection when a change in a setting value SP is detected, when data collection by the data recording portion is stopped, and the direction of change in the setting value SP is in the same direction as the direction of change of the setting value SP that the trigger for starting data collection; a data collection terminating portion that terminates data collection by stopping the data recording portion when the time elapsed after the commencement of data collection has arrived at the data collection termination time limit that is set in advance, when data collection is being performed by the data recording portion; and a data displaying portion that switches the display of a graph display of the most recent time-series data, from the commencement of the most recent data collection until the termination of the most recent data collection, recorded by the data recording portion, when the data collection has been completed.

In one example configuration of the controlling system according to the present disclosure, the data recording portion records, with each operating period, an electric current value CT, in addition to the setting value SP, the process variable PV, and/or the manipulated variable MV, as data to be recorded.

In one example configuration of the controlling system according to the present disclosure, the data displaying portion displays a graph of the most recent time-series data superimposed with reference data that is time-series data for comparison.

One example configuration of the controlling system according to the present disclosure further includes: a difference displaying portion that quantifies, and displays together with the graph, a difference between the most recent time-series data and the reference data.

In one example configuration of the controlling system according to the present disclosure, the reference data is time-series data collected and recorded in the cycle immediately previous to that of the most recent time-series data.

In one example configuration of the controlling system according to the present disclosure, the reference data is time-series data indicating ideal values for the data that is to be collected.

In one example configuration of the controlling system according to the present disclosure, the reference data is average data of a plurality of time-series data, collected and recorded over a plurality of cycles previous to the most recent time-series data.

Moreover, in one example configuration of the controlling system according to the present disclosure, the data displaying portion switches the display to the most recent time-series data when a specific amount of time has elapsed since the point in time of the commencement of collection of the most recent time-series data.

A data collecting/displaying method according to the present disclosure includes: a manipulated variable calculating step for calculating and outputting, with each operating period, a manipulated variable MV based on a setting value SP and a process variable PV; a data collection initiating step for activating a data recording portion, to start data collection when a change in a setting value SP is detected, when data collection by the data recording portion is stopped, and the direction of change in the setting value SP is in the same direction as the direction of change of the setting value SP that the trigger for starting data collection; a data recording step for recording by the data recording portion, with each operating period, the setting value SP, the process variable PV, and/or the manipulated variable MV, as data to be collected; an elapsed time measuring step for measuring elapsed time after commencement of data collection; a data collection terminating step for terminating data collection by stopping the data recording portion when the time elapsed after the commencement of data recording has arrived at the data collection termination time limit that is set in advance, when data collection is being performed by the data recording portion; and a data displaying step for switching the display of a graph display of the most recent time-series data, from the commencement of the most recent data collection until the termination of the most recent data collection, recorded by the data recording portion, when the data collection has been completed.

The present invention makes it possible to secure orderliness when dividing, into individual data sets for each single rising/falling movement of the process variable PV, the data that is to be collected when the process variable PV rises and falls repetitively. Moreover, when, in the present invention, the data collection has been terminated, the display is switched from a graph of the time-series data collected immediately previously to the time-series data collected most recently, and thus the shapes of the time-series data for which the timings of the rising/falling movements are aligned will be displayed with each cycle of rising/falling motion of the process variable PV. As a result, the operator is able to monitor this display to get a feeling of an after-image, to check for differences (changes) from the data set collected in the previous cycle. That is, the operator is able to check the state of rising and falling movement rapidly.

Moreover, the present invention enables the operator to check for differences (changes) in data easily through displaying a graph wherein the most recent time-series data is superimposed on reference data that is time-series data for comparison.

Moreover, the present invention enables the operator to check for differences (changes) in the data even more easily through quantifying, and displaying together with the graph, the differences between the most recent time-series data and the reference data.

Moreover, the present invention enables a reduction in the probability that the operator will mistake the timing for a check, through switching the display to the most recent time-series data when a specified time interval has elapsed after the commencement of collection of the most recent time-series data.

### BRIEF DESCRIPTIONS OF THE DRAWINGS

FIG. 1 is a block diagram illustrating a structure of a controller according to Example according to the present disclosure.

FIG. 2 is a flowchart illustrating the operation of the controller according to the Example according to the present disclosure.

FIG. 3 is a diagram for explaining the data collecting operation of the controller according to the Example according to the present disclosure.

FIG. 4 is a diagram illustrating an example of dated displaying in the Example according to the present disclosure.

FIG. 5 is a block diagram illustrating a structure of a controller according to Another Example according to the present disclosure.

FIG. 6 is a flowchart illustrating the operation of the controller according to the Another Example according to the present disclosure.

FIG. 7 is a diagram illustrating an example of dated displaying in the Another Example according to the present disclosure.

### DETAILED DESCRIPTION

In an aspect of the present invention, as an example of data that is collected there is a setting value SP, a process variable PV, a manipulated variable MV, and an electric current value CT in a heater. The manipulated variable MV is calculated within the regulator based on the setting value SP, which is set in the regulator (which is, for example, a temperature regulator), and a process variable PV that is inputted from a measurement instrument (a sensor) that is connected to the regulator. The electric current value CT is inputted into the regulator in order to detect a burnt-out heater. That is, the setting value SP, the process variable PV, the manipulated variable MV, and the electric current value CT are all collected by the regulator, and are used by the hardware.

Changes in the process variable PV and the manipulated variable MV are triggered by changes in the setting value SP. Consequently, for a heating operation, a change in the setting value SP in the rising direction, when data collection is stopped, should be the trigger for initiating data collection. For a cooling operation, a change in the setting value SP in the falling direction, when data collection is stopped, should be the trigger for initiating data collection. Moreover, the data collection may be terminated when the data collection has exceeded a specified time interval, based on, for example, processing time that is ascertained in advance.

This produces a state wherein individual data can be extracted, and the time required until the process variable PV and the manipulated variable MV actually begin to change, after the point in time of the commencement of data collection, can be caused to be regular and uniform, making it possible for checks to include also the shifts in the individual heating/cooling cycles, if heating/cooling is performed repetitively.

Moreover, if the individual data are graphed each time the individual data are extracted, then the switching of the display will be performed with regular timing, enabling the operator to check for differences (changes), without error in the timing of the checks, at the switching of the display, for example, from the individual data extracted in the previous cycle. That is, the operator is able to check the state of the rising/falling movement (the state of the heating/cooling) rapidly.

In another aspect of the present invention, controlling the timing with which the display is switched so as to depend not only on processing after the data collection has been terminated, but also when a time interval that has been set in advance has elapsed after the point in time of the commencement of data collection enables a reduction in the probability of the operator mistaking the timing of the check. In this case, the time interval should be set so as to have as much margin as possible in performing the check on the process after the data collection has been completed, so that even if there is a state wherein the display can be switched most rapidly, the switch of the display is delayed (somewhat) until the specified time interval has elapsed. While this may be considered to be inefficient, if the process variable PV undergoes repetitive rapid rising and falling movement (for example, rapid heating/cooling), this would not require the control operation itself to be delayed, and thus this does not cause a problem.

In yet another aspect of the present invention, for example, superimposing the most recently extracted data together with reference data, such as the data extracted in the previous cycle, enables the operator to check for differences (changes) more easily. However, in the case of displaying the data extracted in the previous cycle, the operator might not be able to check for differences (changes) if there is a gradual change in the state of the rising/falling movement (the state of heating/cooling). Given this, preferably reference data such as data from an ideal control operation should be used. Moreover, quantifying, and displaying at the same time, the differences between the data that are displayed superimposed enables the operator to check for differences (changes) even more easily.

### EXAMPLE

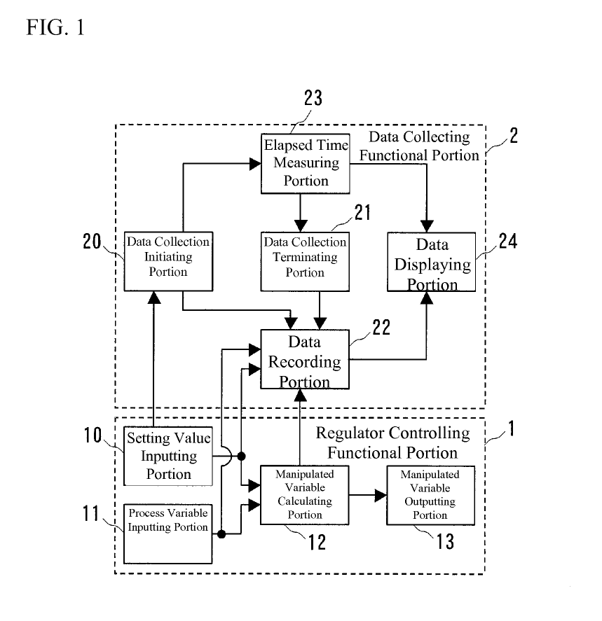

Forms for carrying out the present disclosure will be explained below in reference to the figures. The present example corresponds to the aspect and the another aspect of the present invention. FIG. 1 is a block diagram illustrating a structure for a controller according to Example according to the present disclosure. A regulator controlling functional portion 1, which is a typical structure that is conventionally provided in a regulator, and a data collecting functional portion 2, which is a distinctive structure in the present example, are provided.

The regulator controlling functional portion 1 is provided with: a setting value inputting portion 10 that inputs a setting value SP from outside of the regulator; a process variable inputting portion 11 that inputs a process variable PV from a measurement instrument; a manipulated variable calculating portion 12 that calculates a manipulated variable MV based on the setting value SP and the process variable PV; and a manipulated variable outputting portion 13 that outputs the manipulated variable MV to outside of the regulator.

The data collecting functional portion 2 is provided with: a data collection initiating portion 20 that evaluates the data collection start time and initiates the data collection; a data collection terminating portion 21 that evaluates the data collection termination and that stops the data collection; a data recording portion 22 that records, for each operating period, at least one data that is to be collected, from among a setting value SP, a process variable PV, and a manipulated variable MV; an elapsed time measuring portion 23; and a data displaying portion 24 that switches a display to displaying a graph of the most recent time-series data, from the commencement of the most recent data collection to the termination of the most recent data collection, recorded by the data recording portion 22, when the data collection has been terminated.

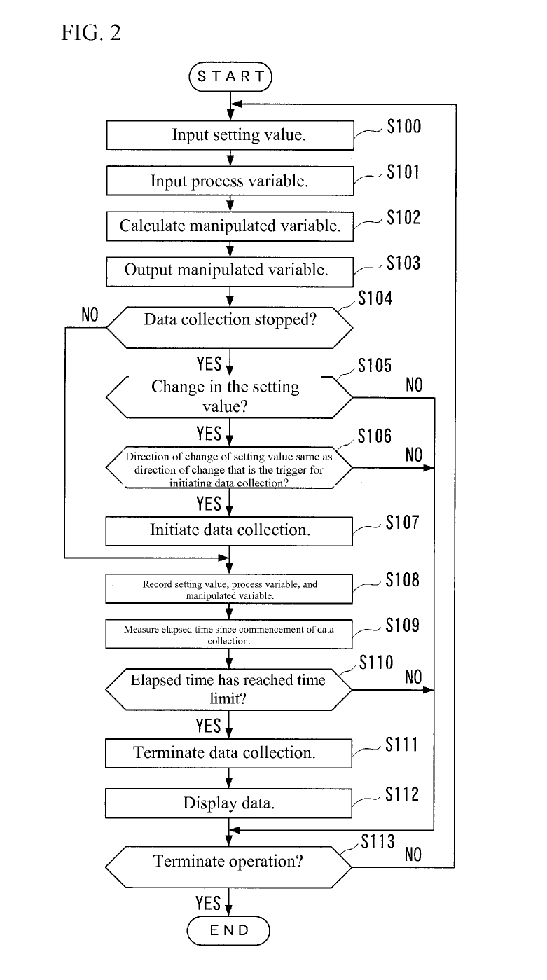

The operation of the regulator according to the present example will be explained next in reference to FIG. 2. The setting value SP is set by an operator, or the like, and is inputted into the manipulated variable calculating portion 12 through the setting value inputting portion 10 (FIG. 2, Step S100).

The process variable PV is measured by a measurement instrument, not shown, and inputted into the manipulated variable calculating portion 12 through the process variable inputting portion 11 (FIG. 2, Step S101).

The manipulated variable calculating portion 12 calculates the manipulated variable MV in accordance with a known control calculating algorithm so that the process variable PV will match the setting value SP (FIG. 2, Step S102). The control calculating algorithm is, for example, a PID.

The manipulated variable outputting portion 13 outputs, to the controlled subject, the manipulated variable MV that has been calculated by the manipulated variable calculating portion 12 (FIG. 2, Step S103). When the control target is, for example, a heat treatment furnace, a power regulator for supplying electric power to the heater in the heat treatment furnace is the actual destination to which the manipulated variable MV will be outputted.

If, when the data collection by the data recording portion 22 is terminated (FIG. 2, Step S104: YES), the data collection initiating portion 20 detects a change in the setting value SP that is inputted from the setting value inputting portion 10 (FIG. 2, Step S105: YES), and the direction of change of the setting value SP is in the same direction as the direction of change of the setting value SP that that is the trigger for starting data collection (FIG. 2, Step S106: YES), then the data recording portion 22 is activated, and data collection is started (FIG. 2, Step S107). The data collection initiating portion 20 evaluates that there has been a change in a setting value SP when a setting value SP that has been inputted from the setting value inputting portion 10 is different from the setting value SP from the immediately previous operating period.

For example, if data is collected and recorded during a heating operation, then the “rising direction” may be recorded in the data collection initiating portion 20 as the direction of change of the setting value SP to serve as the trigger for initiating data collection. As a result, data collection will start when the setting value SP has been changed in the upward direction. Moreover, if data is collected and recorded during a cooling operation, then the “falling direction” may be recorded in the data collection initiating portion 20 as the direction of change of the setting value SP to serve as the trigger for initiating data collection.

Following this, the data recording portion 22 that has been activated records the setting value SP that has been inputted from the setting value inputting portion 10, the process variable PV that is inputted from the process variable inputting portion 11, and the manipulated variable MV that is calculated by the manipulated variable calculating portion 12 (FIG. 2, Step S108).

The elapsed time measuring portion 23 measures the amount of time that has elapsed after the commencement of data collection (FIG. 2, Step S109).

When the elapsed time after the commencement of data collection has reached a time limit for the termination of data collection, set in advance, when data is being collected by the data recording portion 22 (FIG. 2, Step S110: YES), then the data collection terminating portion 21 stops the data recording portion 22, to terminate the data collection (FIG. 2, Step S111).

When a specified amount of time has elapsed after the point in time of commencement of data collection of a data set (the most recent rising/falling data that has been extracted), which is time-series data from the commencement of the most recent data collection until the termination of the data collection, then, after the data recording portion 22 is stopped to terminate the data collection, the data displaying portion 24 displays this data set, that is recorded in the data recording portion 22, in a graph that is aligned to a time series frame that has been specified in advance (FIG. 2, Step S112). At this time, the specified time is set to a time interval that is longer than the aforementioned time limit.

The processes in Step S100 through S112 as described above are repeated at each control interval until the control is terminated through, for example, an instruction from an operator (FIG. 2, Step S113: YES).

Note that this displaying of a graph aligned with a time series frame that has been specified in advance refers to, for example, displaying a data set with the time at the beginning of the data (the time at which data collection commenced) used as the beginning of time on the time axis (the horizontal axis) of the graph. Because the data set is collected each time there is a rising/falling movement of the process variable PV, the time of the beginning of the data will not change, so displaying the data set in a graph with the time of the beginning of the data at the beginning time on the time axis of the graph enables each individual data set, which is partitioned by each individual rising/falling movement cycle of the process variable PV, to be displayed using an identical standard, thus enabling the differences in the data sets to be identified easily.

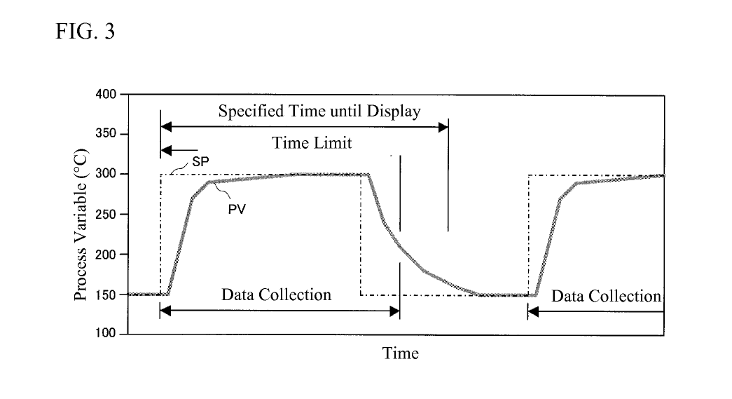

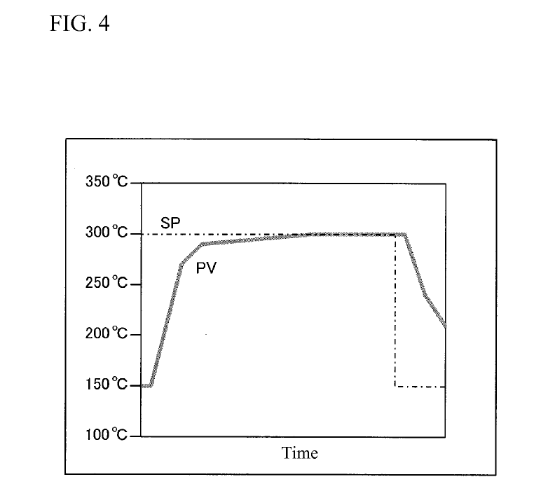

FIG. 3 is a diagram for explaining the data collection operation in a regulator according to the present example, where the horizontal axis in FIG. 3 is time and the vertical axis is the process variable PV. Here the explanation will assume that the setting value SP is a temperature setting value, and the process variable PV is a temperature measurement, in a case such as, for example, collecting data during a heating operation in a heat treatment furnace. In the example in FIG. 3, the data collection commences at the point in time of the change of the setting value SP from 150° C. to 300° C., and the data collection is terminated when the elapsed time after the commencement of data collection has reached the time limit for terminating the data collection. Given this, the collected data is displayed as shown in FIG. 4, for example, when the specified time after the commencement of data collection has elapsed. In the example in FIG. 4, a graph of the time-series data for the setting value SP and the process variable PV is displayed. Thereafter, data collection and graph display is performed each time similar heating/cooling operations are performed.

As set forth above, the present example makes it possible to secure orderliness when dividing, into individual data sets for each single rising/falling movement of the process variable PV, the data that is to be collected when the process variable PV rises and falls repetitively. This regularity, specifically, proper regularity so that the beginning of the data set is at the point in time of a change in the setting value SP, causes proper regulation of a change in the manipulated variable MV or a process variable PV as the timing of the start of a control operation.

Moreover, in the present example, when the data collection has been terminated, the display is switched from the graph of the data set collected in the previous cycle to a graph of the most recent data set collected, in the current cycle, and thus the shapes of the time-series data, wherein the timing of the rising/falling movements are aligned will be displayed for each individual rising/falling cycle of the process variable PV. As a result, the operator is able to monitor this display to get a feeling of an after-image, to check for differences (changes) from the data set collected in the previous cycle. That is, the operator is able to check the state of rising and falling movement of the process variable PV rapidly. Moreover, in the present invention the display is switched when a reference time interval has elapsed after the point in time of commencement of data collection, thus enabling a further reduction in the probability that the operator will mistake the timing of the check.

In the present example, the object is to check the state of the rising/falling movement of a high-speed process variable PV, and thus while the description is for a form wherein all of the structural elements are built-in within the regulator, the form may be one wherein the data displaying portion 24 is connected outside of the regulator using a high-speed communication function. In this case, the control system that embodies the technical concept of the present disclosure is formed through the regulator and the data displaying portion 24 that is provided external thereto.

Note that while in the present example three types of data, specifically the setting value SP, the process variable PV, and the manipulated variable MV were collected, there is no limitation thereto, but instead the system may be such that only one of these three is collected.

### Another Example

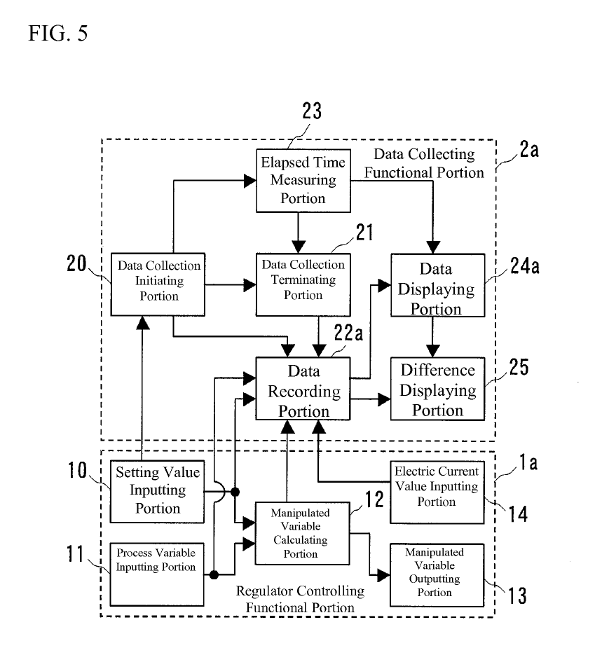

Another Example according to the present disclosure will be explained next. The present example corresponds to the another aspect and the yet another aspect of the present invention. FIG. 5 is a block diagram illustrating a structure of a controller according to Another Example according to the present disclosure, where structures identical to those of FIG. 1 are assigned identical codes. The regulator according to the present example is provided with a regulator controlling functional portion 1a and a data collecting functional portion 2a.

The regulator controlling functional portion 1 a includes a setting value inputting portion 10, a process variable inputting portion 11, a manipulated variable calculating portion 12, a manipulated variable outputting portion 13, and an electric current value inputting portion 14 for inputting an electric current value CT for the electric current that flows in the halogen lamp (a high-speed heater).

The data collecting functional portion 2a is provided with: a data collection initiating portion 20; a data collection terminating portion 21; a data recording portion 22a that records, with each operating period, data that is to be collected as the electric current value CT, in addition to the setting value SP, the process variable PV, and/or the manipulated variable MV; an elapsed time measuring portion 23; a data displaying portion 24a that superimposes, and displays as a graph, reference data, which is time-series data for a comparison, together with the most recent time-series data that has been recorded in the data recording portion 22a, when the data collection has been completed; and a difference displaying portion 25, that quantifies the differences between the most recent time-series data and the reference data, and displays them at the same time as switching the display by the data displaying portion 24a.

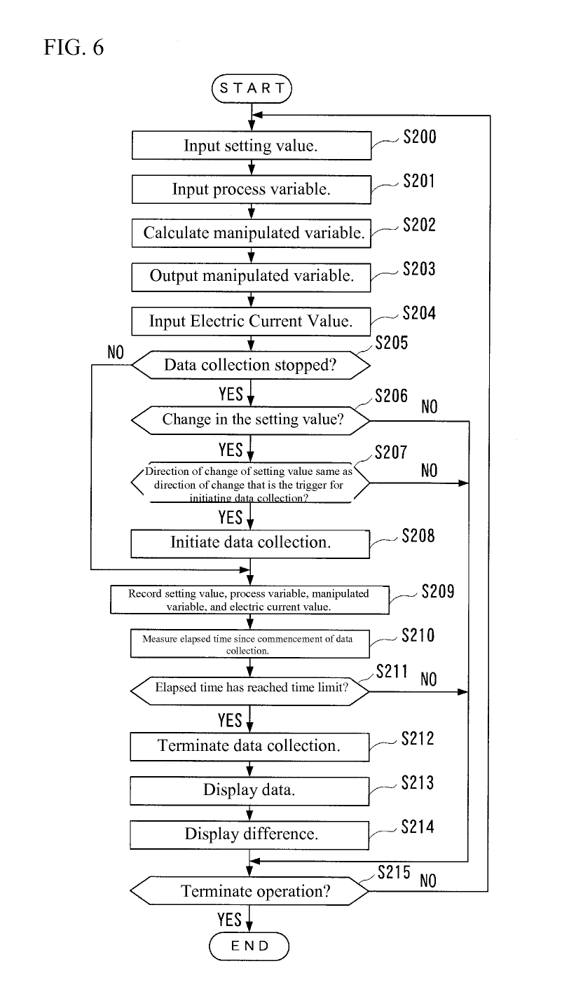

The operation of the regulator according to the present example will be explained next in reference to FIG. 6. The procedures in Step S200 through S203 in FIG. 6 are identical to the respective Step S100 through S103 in FIG. 2, so explanations thereof will be omitted. In the present example, the control target is a heat treatment furnace that is provided with a halogen lamp (a high-speed heater), so the actual output destination for the manipulated variable MV is the electric power regulator for supplying electric power to the halogen lamp. In this case, the setting value SP is a temperature setting value, and the process variable PV is a measured temperature that is measured by an instrument (sensor) of the heat treatment furnace.

The electric current value inputting portion 14 acquires an electric current value CT from an electric current value measuring portion (not shown) that measures the value CT of the electric current that flows in the halogen lamp (the high-speed heater) (FIG. 6, Step S204).

If, when the data collection by the data recording portion 22a is terminated (FIG. 6, Step S205: YES), the data collection initiating portion 20 detects a change in the setting value SP that is inputted from the setting value inputting portion 10 (FIG. 6, Step S206: YES), and the direction of change of the setting value SP is in the same direction as the direction of change of the setting value SP that is the trigger for starting data collection (FIG. 6, Step S207: YES), then the data recording portion 22a is activated, and data collection is started (FIG. 6, Step S208).

In the present example, if data is collected and recorded during a heating operation in a heat treatment furnace, then the “rising direction” (the heating direction) is recorded in advance in the data collection initiating portion 20 as the direction of change of the setting value SP to serve as the trigger for initiating data collection. As a result, data collection will start when the setting value SP has been changed in the upward direction.

Following this, the data recording portion 22a that has been activated records the setting value SP (the temperature setting value) that has been inputted from the setting value inputting portion 10, the process variable PV (the measured temperature) that is inputted from the process variable inputting portion 11, the manipulated variable MV (the heater manipulated variable) that is calculated by the manipulated variable calculating portion 12, and the electric current value CT that is inputted from the electric current value inputting portion 14 (FIG. 6, Step S209).

The elapsed time measuring portion 23 measures the amount of time that has elapsed after the commencement of data collection (FIG. 6, Step S210).

When the elapsed time after the commencement of data collection has reached a time limit for the termination of data collection, set in advance, when data is being collected by the data recording portion 22a (FIG. 6, Step S211: YES), then the data collection terminating portion 21 stops the data recording portion 22a, to terminate the data collection (FIG. 6, Step S212).

When the data recording portion 22a has been stopped, terminating the data collection, the data displaying portion 24a displays a data set D1(i) (where i is the datum number of n time-series data that have been collected, where i=1 through n), which is time-series data from the commencement of the most recent data collection until the termination of the most recent data collection, recorded by the data recording portion 22a, as a graph that is superimposed on a time series frame that has been specified in advance, after a specified time interval has elapsed since the commencement of collection of the data set, and, at the same time, displays, as a graph, superimposed on the data set D1(i), aligned with the same time series frame, a data set D2(i), which is time-series data from the commencement of data collection in the previous cycle to the termination of data collection in the previous cycle, which are recorded in the data recording portion 22a as reference data (FIG. 6, Step S213).

As described above, this displaying of a graph aligned with a time series frame that has been specified in advance refers to displaying a data set with the time at the beginning of the data (the time at which data collection commenced) used as the beginning of time on the time axis of the graph. Consequently, the data sets D1(i) and D2(i) are displayed superimposed together with the starting time of the time series D1(i) and the starting time of the time series D2(i) as the starting time for both on the time axis of the same graph.

The difference displaying portion 25 quantifies the difference E2 in the data between the most recent data set D1(i) and the immediately previous data set D2(i), through calculating using the following formula, and displays it at the same time as the graph displayed by the data displaying portion 24 (FIG. 6, Step S214).

$$\begin{matrix}Expression 1 & \\ E 2 = {\sum }_{i = 1}^{n} \vert D 1 ( i ) - D 2 ( i ) \vert & ( 1 )\end{matrix}$$

At this time, the difference displaying portion 25 calculates and displays the difference E2 for each type of data. In the present example, the setting values SP, the process variable PV, the manipulated variable MV, and the electric current values CT are collected and recorded, and so a difference E2 between the data set for the most recent setting value SP1 and the data set for the immediately previous setting value SP2 may be calculated and displayed, a difference E2 between the data set for the most recent process variable PV1 and the data set for the immediately previous process variable PV2 may be calculated and displayed, a difference E2 between the data set for the most recent manipulated variable MV1 and the data set for the immediately previous manipulated variable MV2 may be calculated and displayed, and a difference E2 between the data set for the most recent electric current value CT1 and the data set for the immediately previous electric current value CT2 may be calculated and displayed.

The processes in Step S200 through S214 as described above are repeated at each operating period until the operation is terminated through, for example, an instruction from an operator (FIG. 6, Step S215: YES).

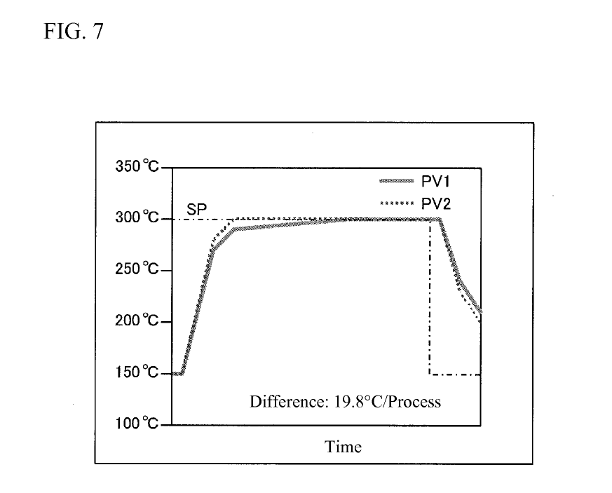

FIG. 7 is a diagram illustrating an example of data display according to the present disclosure. In the example in FIG. 7, setting values SP (=SP1=SP2), the most recent process variable PV1 data set, the immediately previous process variable PV2 data set, and the difference E2=19.8° C. between the most recent process variable PV1 data set and the immediately previous process variable PV2 data set are shown.

In contrast to the Example, wherein a sense of an after image was used, in the present example the operator can identify a difference with reference data for comparison (the immediately previous data set) even more easily.

In the present example, the data displaying portion 24 supplies the reference data, and the difference displaying portion 25 is that which performs the difference calculation. In this sense, the functional blocks are different from those of a simple displaying portion.

Although the electric current value CT is a state variable that is particularly difficult to synchronize to time and that changes rapidly, in terms of data quality, synchronization of timing with the control operations (the measured temperature PV and the heater manipulated variable MV) is of paramount importance, and so preferably data collection is integrated with the regulator function. Note that for the electric current value CT as well, as was the case for the process variable PV, a graph may be displayed wherein the most recent electric current value CT1 data set and the immediately previous electric current value CT2 data set are superimposed through alignment with a specified time-series frame.

In the present example, the object is to check the state of the rising/falling movement of a high-speed process variable PV, and thus while the description is for a form wherein all of the structural elements are built-in within the regulator, the form may be one wherein the data displaying portion 24 and the difference displaying portion 25 are connected outside of the regulator using a high-speed communication function. In this case, the control system that embodies the technical concept of the present disclosure is formed through the regulator, and the data displaying portion 24 and the difference displaying portion 25 that are provided external thereto.

### Yet Another Example

Yet Another Example according to the present disclosure will be explained next. The present example is another example corresponding to the another aspect and the yet another aspect of the present invention. In the present example as well, the structure and flow of processing in the regulator are the same as in the Another Example, so the explanation will reference FIG. 5 and FIG. 6.

The processes in Step S200 through S212 of FIG. 6 are as were explained in the Another Example.

When the data recording portion 22a has been stopped, terminating the data collection, the data displaying portion 24a of the present example displays a data set D1(i), which is time-series data from the commencement of the most recent data collection until the termination of the most recent data collection, recorded by the data recording portion 22a, as a graph that is superimposed on a time series frame that has been specified in advance, after a specified time interval has elapsed since the commencement of collection of the data set, and, at the same time, displays, as a graph, superimposed on the data set D1(i), aligned with the same time series frame, a data set D3(i), which is time-series data indicating the ideal values for the data set D1(i), stored in advance in the data recording portion 22a, as reference data (FIG. 6, Step S213). In this case, the data sets D1(i) and D3(i) may be displayed superimposed together with the starting time of the time series D1(i) (the time at which the data collection commenced) and the starting time of the time series D3(i) as the starting time for both on the time axis of the same graph.

The difference displaying portion 25 in the present example quantifies the difference E3 in the data between the most recent data set D1(i) and the data set D3(i), through calculating using the following formula, and displays it at the same time as the graph displayed by the data displaying portion 24 (FIG. 6, Step S214).

$$\begin{matrix}Expression 2 & \\ E 3 = {\sum }_{i = 1}^{n} \vert D 1 ( i ) - D 3 ( i ) \vert & ( 2 )\end{matrix}$$

At this time, the difference displaying portion 25 calculates and displays the difference E3 for each type of data. In the present example, the setting values SP, the process variable PV, the manipulated variable MV, and the electric current values CT are collected and recorded, and so a difference E3 between the data set for the most recent process variable PV1 and the ideal data set for the process variable PV3 may be calculated and displayed, a difference E3 between the data set for the most recent manipulated variable MV1 and the ideal data set for the manipulated variable MV3 may be calculated and displayed, and a difference E3 between the data set for the most recent electric current value CT1 and the ideal data set for the electric current value CT3 may be calculated and displayed.

Note that while data illustrating ideal control operations is used as the reference data in the present example, average data from a plurality of data sets collected and recorded over a plurality of cycles prior to the most recent data set may be used instead as the reference data.

The controlling system that includes the regulator explained in the three examples, namely the Example, the Another Example and the Yet Another Example, may be embodied through a computer that is equipped with a CPU, a storage device, and an interface, combined with a program for controlling these hardware resources. The CPU executes the processes explained in the three examples, namely the Example, the Another Example and the Yet Another Example, in accordance with a program that is stored in the memory device. As described above, the controlling system may be divided into two parts: a computer for embodying the regulator and a computer for embodying the data displaying portion 24 and the difference displaying portion 25. In this case, the CPUs for the two computers execute the processes described in the three examples, namely the Example, the Another Example and the Yet Another Example, following programs that are stored in the storage devices of the respective computers.

The present invention can be applied to control systems that include regulators, such as temperature regulators, that are provided with data collection functions.

1. A controlling system comprising:
a manipulated variable calculating portion that calculates and outputs, with each operating period, a manipulated variable MV based on a setting value SP and a process variable PV;
an elapsed time measuring portion that measures elapsed time after commencement of data collection;
a data recording portion that records, with each operating period, the setting value SP, the process variable PV, and/or the manipulated variable MV, as data to be collected;
a data collection initiating portion that activates the data recording portion, to start data collection when a change in a setting value SP is detected, when data collection by the data recording portion is stopped, and the direction of change in the setting value SP is in the same direction as the direction of change of the setting value SP that the trigger for starting data collection;
a data collection terminating portion that terminates data collection by stopping the data recording portion when the time elapsed after the commencement of data collection has arrived at the data collection termination time limit that is set in advance, when data collection is being performed by the data recording portion; and
a data displaying portion that switches the display of a graph display of the most recent time-series data, from the commencement of the most recent data collection until the termination of the most recent data collection, recorded by the data recording portion, when the data collection has been completed.

2. The controlling system as set forth in claim 1, wherein:
the data recording portion records, with each operating period, an electric current value CT, in addition to the setting value SP, the process variable PV, and/or the manipulated variable MV, as data to be recorded.

3. The controlling system as set forth in claim 1, wherein:
the data displaying portion displays a graph of the most recent time-series data superimposed with reference data that is time-series data for comparison.

4. The controlling system as set forth in claim 3, further comprising:
a difference displaying portion that quantifies, and displays together with the graph, a difference between the most recent time-series data and the reference data.

5. The controlling system as set forth in claim 3, wherein:
the reference data is time-series data collected and recorded in the cycle immediately previous to that of the most recent time-series data.

6. The controlling system as set forth in claim 3, wherein:
the reference data is time-series data indicating ideal values for the data that is to be collected.

7. The controlling system as set forth in claim 3, wherein:
the reference data is average data of a plurality of time-series data, collected and recorded over a plurality of cycles previous to the most recent time-series data.

8. The controlling system as set forth in claim 1, wherein:
the data displaying portion switches the display to the most recent time-series data when a specific amount of time has elapsed since the point in time of the commencement of collection of the most recent time-series data.

9. A data collecting/displaying method comprising:
a manipulated variable calculating step for calculating and outputting, with each operating period, a manipulated variable MV based on a setting value SP and a process variable PV;
a data collection initiating step for activating a data recording portion, to start data collection when a change in a setting value SP is detected, when data collection by the data recording portion is stopped, and the direction of change in the setting value SP is in the same direction as the direction of change of the setting value SP that the trigger for starting data collection;
a data recording step for recording by the data recording portion, with each operating period, the setting value SP, the process variable PV, and/or the manipulated variable MV, as data to be collected;
an elapsed time measuring step for measuring elapsed time after commencement of data collection;
a data collection terminating step for terminating data collection by stopping the data recording portion when the time elapsed after the commencement of data recording has arrived at the data collection termination time limit that is set in advance, when data collection is being performed by the data recording portion; and
a data displaying step for switching the display of a graph display of the most recent time-series data, from the commencement of the most recent data collection until the termination of the most recent data collection, recorded by the data recording portion, when the data collection has been completed.

10. The data collecting/displaying method as set forth in claim 9, wherein:
the data recording step includes a step for recording, with each operating period, an electric current value CT, in addition to the setting value SP, the process variable PV, and/or the manipulated variable MV, as data to be recorded.

11. The data collecting/displaying method as set forth in claim 9, wherein:
the data displaying step includes a step for displaying a graph of the most recent time-series data superimposed with reference data that is time-series data for comparison.

12. The data collecting/displaying method as set forth in claim 11, further including:
a difference displaying step for quantifying, and displaying together with the graph, a difference between the most recent time-series data and the reference data.

13. The data collecting/displaying method as set forth in claim 11, wherein:
the reference data is time-series data collected and recorded in the cycle immediately previous to that of the most recent time-series data.

14. The data collecting/displaying method as set forth in claim 11, wherein:
the reference data is time-series data indicating ideal values for the data that is to be collected.

15. The data collecting/displaying method as set forth in claim 11, wherein:
the reference data is average data of a plurality of time-series data, collected and recorded over a plurality of cycles previous to the most recent time-series data.

16. The data collecting/displaying method as set forth in claim 9, wherein:
the data displaying step switches the display to the most recent time-series data when a specific amount of time has elapsed since the point in time of the commencement of collection of the most recent time-series data.
